(19) United States
(12) Patent Application Publication
(10) Pub. No.: US 2010/0212509 A1
(43) Pub. Date: Aug. 26, 2010

(54) SAFETY AND GUIDE TYPE BREWING KETTLE

(76) Inventors: Pao-Wu Tien, Taipei City (TW); Yu-Mei Tien Lin, Taipei City (TW)

Correspondence Address: LEONG C LEI, PMB # 1008, 1867 YGNACIO VALLEY ROAD, WALNUT CREEK, CA, 94598, US

(21) Appl. No.: 12/703,798

(22) Filed: Feb. 11, 2010

(30) Foreign Application Priority Data
Feb. 20, 2009 (TW) 098105485
Aug. 28, 2009 (TW) 098215872

(51) Int. Cl. A47J 31/10; A47J 31/18

(52) U.S. Cl. 99/305

(57) ABSTRACT

A safety and guide type brewing kettle includes a kettle body, a water stopper, a screen filter, and a retention disk. The kettle body has a cove that forms a flow guide plate for guiding liquid droplets formed on the cover into the kettle body. The kettle body has a bottom forming a through bore that receives therein a plug, which forms a through hole and an engagement section. The water stopper is arranged to block the through hole for eliminating undesired leaking. The kettle body has a lower circumference forming a projecting wall that forms legs to enclose and stably hold the kettle body. The kettle body forms at least one locking section, which engages an upper side of the screen filter. The screen filter forms a grip section that facilitates assembling/disassembling and cleaning. The screen filter forms a positioning section for positioning the water stopper.

### TECHNICAL FIELD OF THE INVENTION

The present invention generally relates to a safety and guide type brewing kettle.

### DESCRIPTION OF THE PRIOR ART

A conventional liquid brewing device has several disadvantages as follows:

(1) As shown in FIG. 11 of the attached drawings, a conventional liquid brewing device comprises a kettle body 90 that comprises a cover 91 pivotally connected to a handle 92 mounted to one side of the kettle body 90. When the cover 91 is in a closed condition, vapors of the liquid used to brew objects to be brewed goes upward and droplets are formed on an inside surface of the cove 91. When the cover 91 is opened, due to no liquid flow guide means provided on the cover 91, the droplets on the cover 91 will flow along the kettle body 90 and the handle 92 and thus splash to a fixture surface on which the brewing device is placed, leading to poor cleanliness.

(2) The conventional liquid brewing device comprises a filter that is difficult to mount and dismount. Further, the conventional filter is not provided with a vent hole, so that no air interchange is allowed, making the discharge of the brewing liquid very difficult.

(3) Chinese Patent No. ZL97116221.2 and Taiwan Patent Publication No. 351971 disclose a conventional brewing device that has a retention disk set below a cup and the retention disk has a diameter greater than a lower circumference of the cup. The retention disk has at least a portion that is not enclosed and shielded, so that that portion may be unexpectedly contacted by a user, causing liquid leaking through a liquid dispensing structure. Further, the lower circumference of the cup forms a plurality of legs that extend through the retention disk. The legs function to support the cup, but the area defined among the support points formed by the legs is smaller than a projection area of the retention disk, so that the cup may tip easily when placed on a fixture surface, leading to poor stability and safety. Further, the legs extending through the retention disk makes the manufacturing and assembling difficult.

(4) In the conventional brewing device disclosed in Chinese Patent No. ZL97116221.2 and Taiwan Patent Publication No. 351971, a cover, when not properly coupled to the cup, may easily get lost. Further, using a hand to directly grip and lift the cove may cause undesired burning of the hand. Further, the cover is not provided with any flow guide means so that liquid droplets formed on the cover may splash outside, leading to poor cleanliness.

(5) In the device disclosed in Taiwan Patent Publication No. 351971, a filter is secured inside the cup through projecting ribs. After repeated mounting and dismounting of the filter, wear may occur on the projecting ribs and an inside surface of the cup, leading to undesired gap formed therebetween, which leads to easy separation of the filter and may retain therein contaminants.

(6) In the device disclosed in Taiwan Patent Publication No. 351971, the filter is tightly fit to the inside surface of the cup and the filter comprises no means for easy hand holding. A user must use a tool to remove the filter and this makes the mounting/dismounting and cleaning of the filter difficult.

(7) In a conventional brewing device, a through hole is formed in a bottom of the device and a flow control member is provided to selectively block the hole. The flow control member is of a spherical shape. Since no positioning structure for the flow control member is provided in the conventional brewing device, the flow control member may randomly roll inside the device, making it difficult to correctly block the hole and as a result of which, leaking may occur through the hole.

Thus, the present invention is made overcome the above discussed problems.

### SUMMARY OF THE INVENTION

An objective of the present invention is to provide a safety and guide type brewing kettle, which, structurally, is composed of a kettle body having a bottom forming a through bore. The kettle body has a lower circumference from which a projecting wall projects. The kettle body is pivotally connected to a cover. A water stopper is movably received in the kettle body. A screen filter is arranged inside and close to the bottom of the kettle body. A retention disk is mounted under the kettle body through a movable structure and is movable with respect to the kettle body in a vertical direction. The cover forms a flow guide plate, which guides liquid droplets formed on the cover into the kettle body. The through bore of the kettle body receives therein a plug, which forms a through hole having a circumference along which an engagement section is formed for engagement with the water stopper. The kettle body has a lower circumference from which a projecting wall projects, and the projecting wall has a diameter greater than the retention disk and forms a plurality of legs respectively for housing and shielding the retention disk and preventing the kettle body from tipping. The kettle body forms at least one locking section, which engages an upper side of the screen filter to prevent the screen filter from separation. The screen filter forms a grip section that facilitates assembling/disassembling and cleaning, and the screen filter forms a positioning section on an underside thereof, whereby the water stopper is received in the positioning section to be maintained on the through bore.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a brewing kettle of the present invention.

FIG. 2 is an exploded view of the brewing kettle of the present invention.

FIG. 2A is an enlarged view, in sectioned form, of a portion of the brewing kettle of the present invention shown in FIG. 2.

FIG. 3 is a cross-sectional view of the brewing kettle of the present invention in a condition of not dispensing liquid.

FIG. 3A is an enlarged view of a portion of FIG. 3.

FIG. 4 is a cross-sectional view of the brewing kettle of the present invention in a condition of dispensing liquid.

FIG. 4A is an enlarged view of a portion of FIG. 4.

FIG. 5 is a perspective view showing liquid droplets formed on a cover and guided back into a kettle body of the brewing kettle of the present invention.

FIG. 6 is an exploded view of a brewing kettle of the present invention showing a different embodiment of a locking section.

FIG. 6A is an enlarged view, in sectioned form, of a portion of the brewing kettle of the present invention shown in FIG. 6.

FIG. 7 is an exploded view of a brewing kettle of the present invention showing a different embodiment of a structure for coupling a retention disk and a kettle body of the brewing kettle of the present invention.

FIG. 7A is an enlarged view, in sectioned form, of a portion of the brewing kettle of the present invention shown in FIG. 7.

FIG. 8 is a cross-sectional view of the brewing kettle of the present invention shown in FIG. 7 in a condition of not dispensing liquid.

FIG. 9 is a cross-sectional view of the brewing kettle of the present invention shown in FIG. 7 in a condition of dispensing liquid.

FIG. 9A is an enlarged view of a portion of FIG. 9.

FIG. 10 is a perspective view of a screen filter of the brewing kettle of the present invention, showing a different embodiment of a positioning section.

FIG. 11 is a perspective view showing a conventional brewing device in a cover opened condition.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

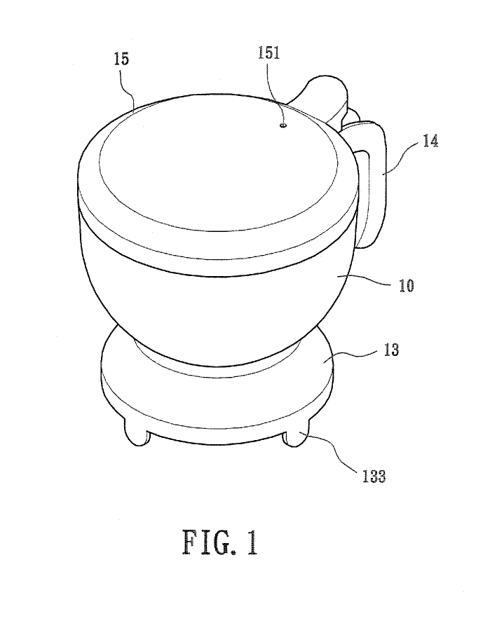

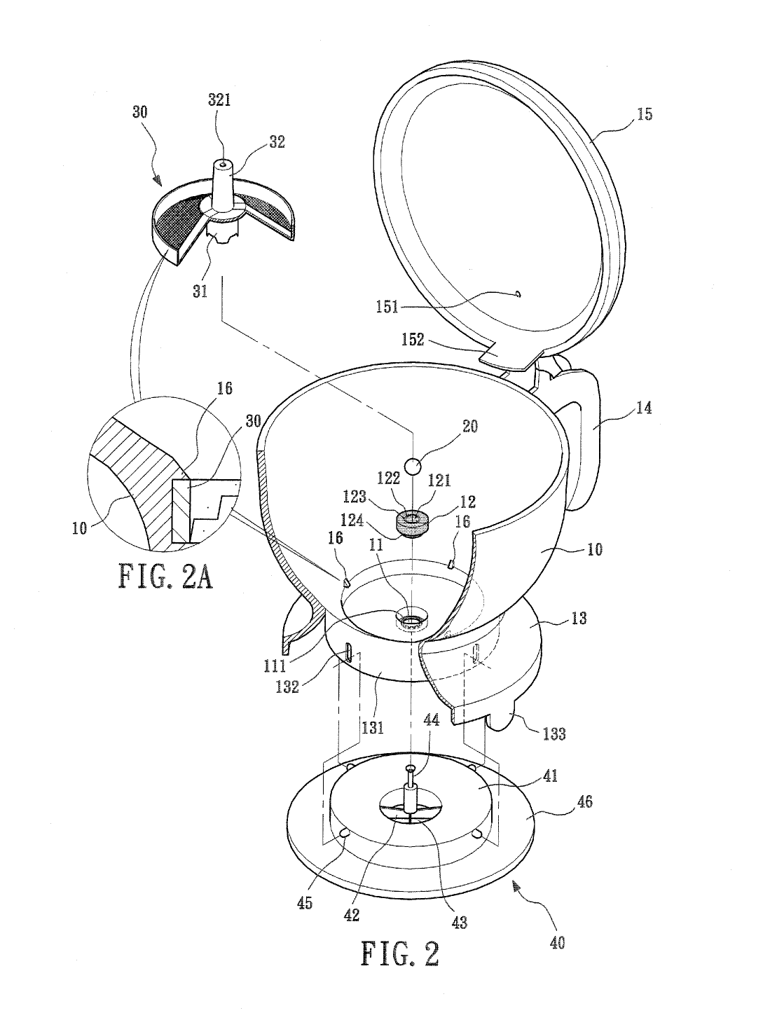

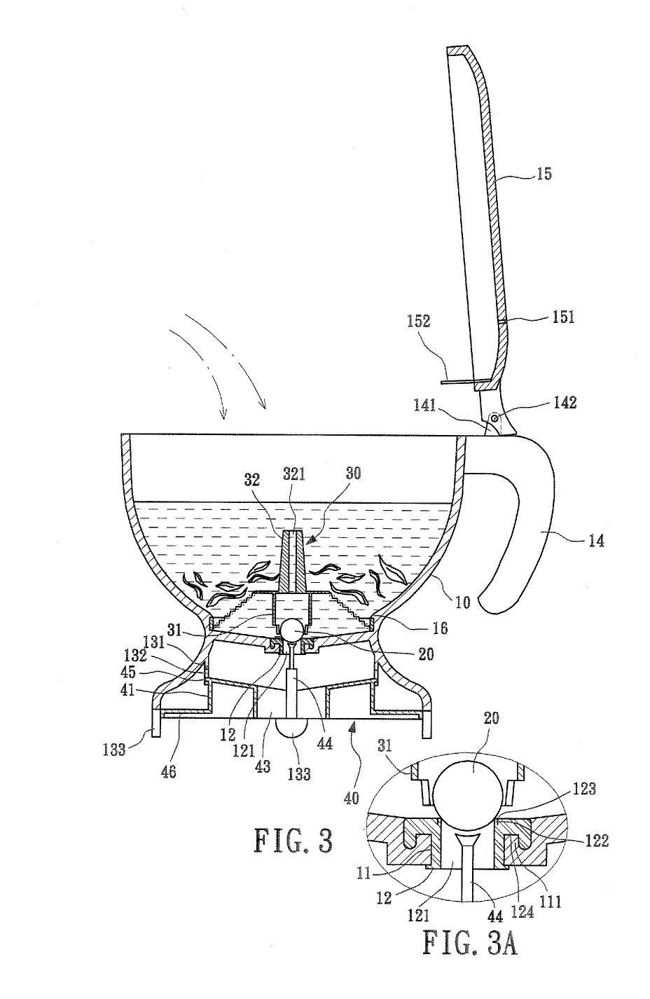

Referring to FIGS. 1, 2, and 3, the present invention provides a brewing kettle comprising a kettle body 10, a water stopper 20, a screen filter 30, and a retention disk 40, which will be described in detailed.

The kettle body 10 forms a receiving space for receiving therein for example coffee powders, tea leaves, or other articles to be brewed. The kettle body 10 has a bottom forming a through bore 11 and a circumferential rim 111 along a circumference of the through bore 11. The inner bottom surface of the kettle body 10 is made inclined to guide brewing liquid toward the through bore 11. The kettle body 10 has a lower circumference from which a circumferential projecting wall 13 projects. The projecting wall 13 comprises a ring support 131 formed inside the projection wall 13. The support 131 forms therein a plurality of slide slots 132. The kettle body 10 has an outer surface on which a handle 14 for hand holding is mounted. The handle 14 forms a projection 141, and the projection 141 uses a pivot 142 to pivo ally connect a cover 15. The cover 15 functions to selectively cover and close a top opening of the kettle body 10. The cover 15 forms a vent hole 151 for air flowing therethrough. The cover 15 forms a flow guide plate 152 at a location adjacent to the pivotal connection. The through bore 11 receives a plug 12 that is made of food-grade rubber and that forms a through hole 121. The through hole 121 has an upper circumference along which an engagement section 122 is formed. A groove 123 is formed adjacent to the engagement section 122 to provide the engagement section 122 with the capability of resilient deformation for establishing tight engagement with the water stopper 20. The plug 12 forms a circumferential fitting channel 124 and the fitting channel 124 is fit to the rim 111. The projecting wall 13 of the kettle body 10 has a diameter greater than that of the retention disk 40, whereby the retention disk 40 is completely enclosed in and shielded by the projecting wall 13. The projecting wall 13 also forms a plurality of legs 133. The kettle body 10 comprises at least one locking section 16, and the locking section 16 can be a projecting portion that forms an inclined surface.

The water stopper 20 comprises a spherical metal object that is arranged on the plug 12 to selectively block the through hole 121, maintaining the kettle body 10 in a normal sealed condition.

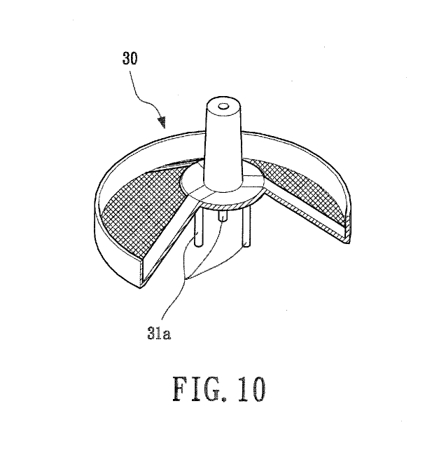

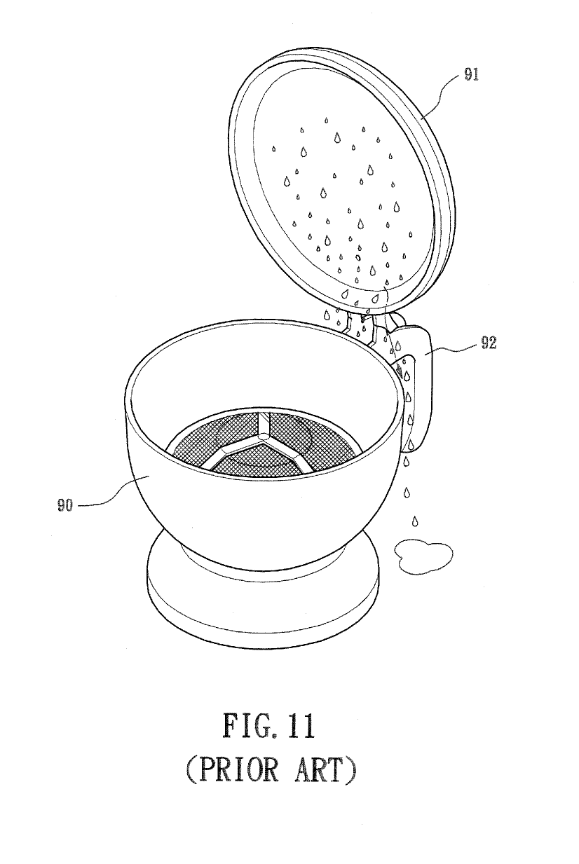

The screen filter 30 functions to filter out impurities generated in the course of brewing. To mount the screen filter 30, the screen filter 30 is forced to slide on and pass over the inclined surface of the locking section 16 to be set in a space under the locking section 16. With locking section 16 engaging an upper side, the screen filter 30 is prevented from separation. The screen filter 30 forms, on an underside thereof, a sleeve-like positioning section 31, and the water stopper 20 is movably received in the positioning section 31 to be maintained on the through bore 11, whereby a function of positioning can thus be realized. Referring to FIG. 10, an alternative positioning section, designated with reference numeral 31a, is composed of a plurality of pillars. The screen filter 30 forms a grip section 32 and the grip section 32 forms vent bore 321.

The retention disk 40 comprises a base 41 that forms a plurality of web boards 42, a plurality of openings 43, a raised post 44, and an extension section 46 located under the base 41. The base 41 has a circumferential surface forming a plurality of pegs 45 respectively corresponding to the slide slots 132 of the projecting wall 13, whereby the pegs 45 are respectively received in the slide slots 132 and the pegs 45 are movable in a vertical direction within the respective slide slots 132 to allow the retention disk 40 to move upward/downward under the kettle body 10. The openings 43 are formed between adjacent web boards 42 for the brewing liquid to flow therethrough. When the raised post 44 is moved upward, the water stopper 20 is pushed away from the through hole 121 and the blocked condition of the through hole 121 is thus released. The raised post 44 can form a recess (not shown) to accommodate and/or hold the water stopper 20. The web boards 42 intersect each other to form a conic configuration (not shown) on an underside of the intersection for guiding the flow of liquid.

The kettle body 10 may receive therein objects to be brewed and brewing liquid can be poured into the kettle body 10. The retention disk 40 is caused by gravity to move downward so that the raised post 44 does not push upward the water stopper 20. Since the water stopper 20 has an outside diameter greater than the through hole 121 of the plug 12, the water stopper 20 can effectively block the through hole 121, whereby brewing can be carried out inside the kettle body 10. The engagement section 122 is in engagement with the water stopper 20 and is thus expanded by being acted upon by the weight of the water stopper 20. Such an expansion induces an inward biasing force for tight engagement with an outer surface of the water stopper 20 so as to compensate eccentricity of deformation of the through hole 121 and thus eliminate leaking through the through hole 121. This helps improving the brewing liquid leaking problems caused by poor circularity of the water stopper and improper deformation of a sealing ring.

Further, the projecting wall 13 houses and shields the retention disk 40, so that leaking problem occurring in the liquid dispensing structure caused by undesired contact of the retention disk 40 by a user can be avoided. Further, the legs 33 of the projecting wall 13 define an area greater than a projection area of the retention disk 40, so that the kettle body 10, when positioned on a horizontal surface, can be soundly maintained in position without tipping, thereby providing excellent stability and safety. Further, the legs 133 of the projecting wall 13 do not extend through the retention disk 40, and this simplifies the manufacturing and assembling thereof.

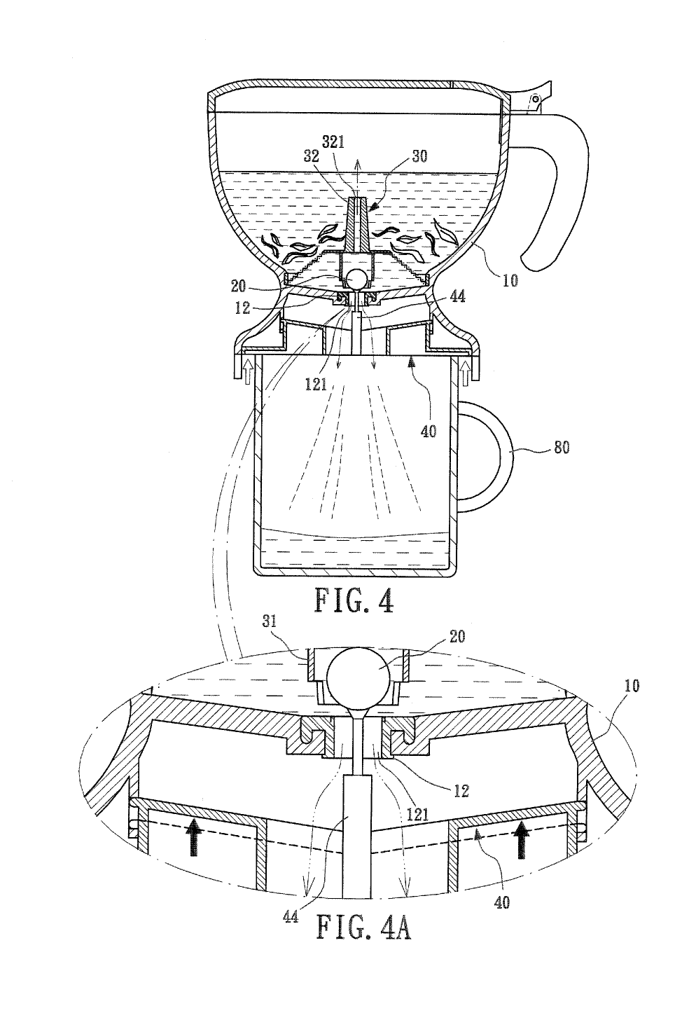

Referring to FIG. 4, the kettle body 10 is positionable on a container 80, whereby the container 80 pushes the retention disk 40 upward. The retention disk 40 is thus caused to move upward and drives the raised post 44 to push the water stopper 20 away from the through hole 121, whereby the brewing liquid contained in the kettle body 10 is allowed to flow through the through hole 121 and the retention disk 40 into the container 80.

During the process when the through hole 121 discharges the brewing liquid, the vent bore 321 provides a passage for air flowing therethrough to facilitate the discharging of the liquid. Further, the grip section 32 allows for easy hand gripping and thus facilitates assembling/disassembling of the screen filter 30 for replacement and cleaning.

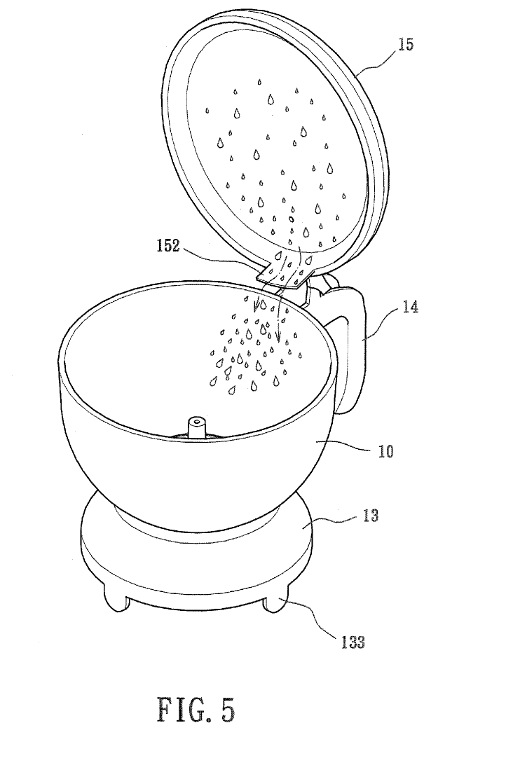

Referring to FIG. 5, when the cover 15 is opened, water droplets formed on the cover 15 flow along and are guided by the flow guide plate 152 to get back into the kettle body 10, rather than splashing outside to the support surface, and this provides an efficacy of cleanliness.

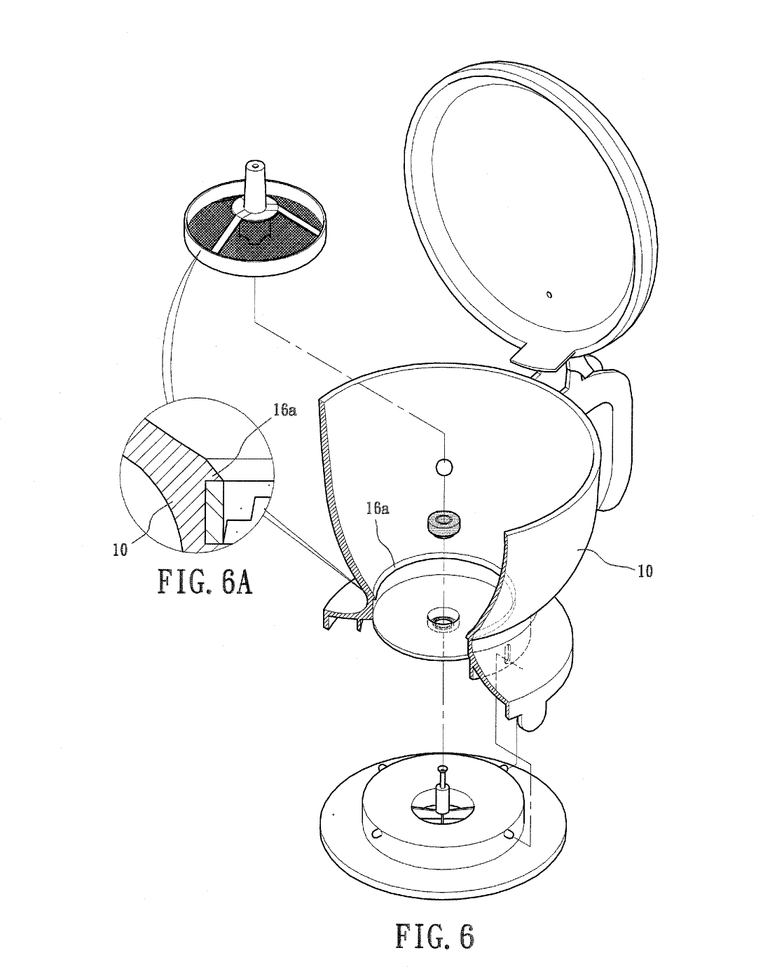

Referring to FIG. 6, the kettle body 10 may alternatively comprise a locking section 16a that is a circumferential rib having an inclined surface.

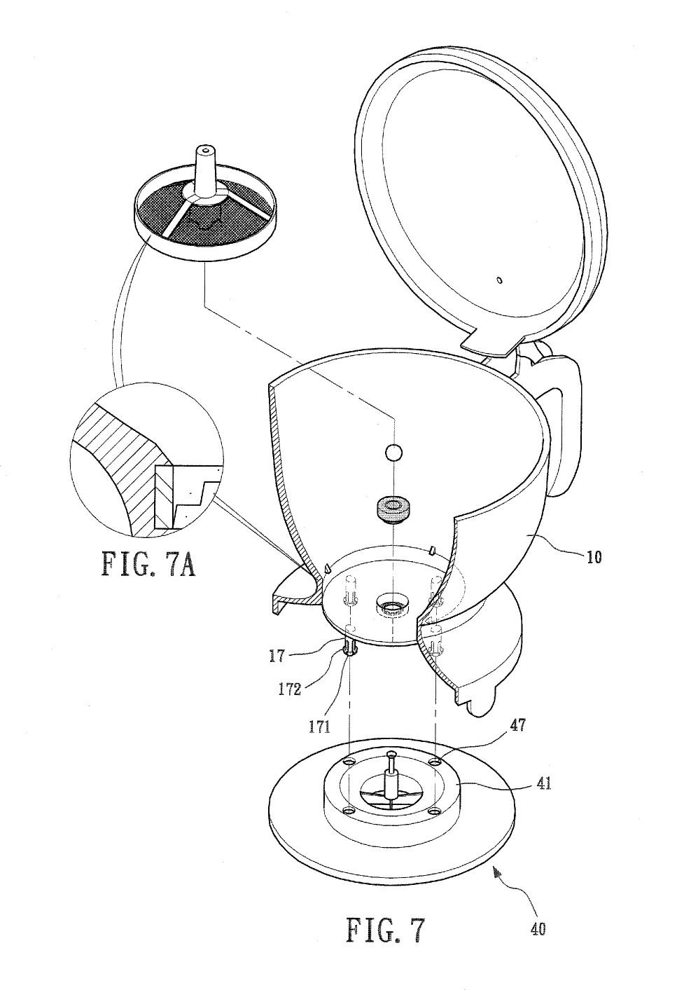

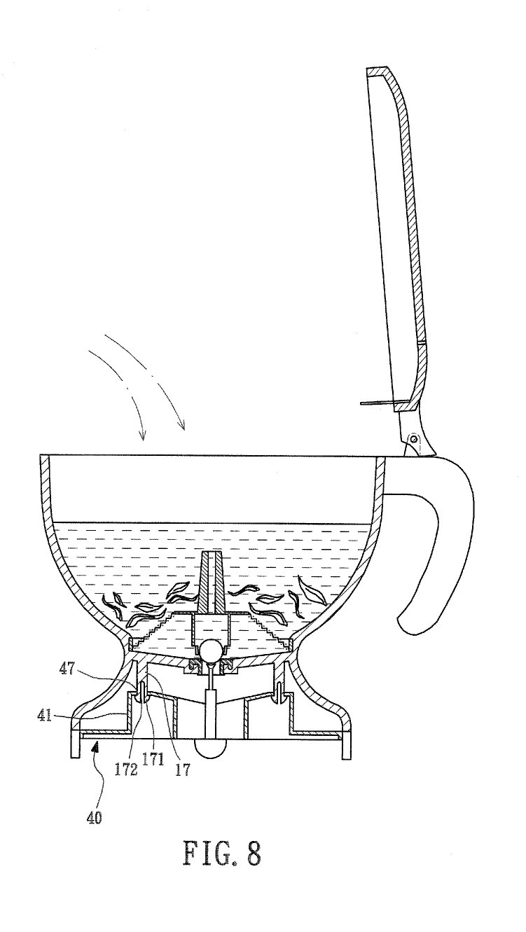

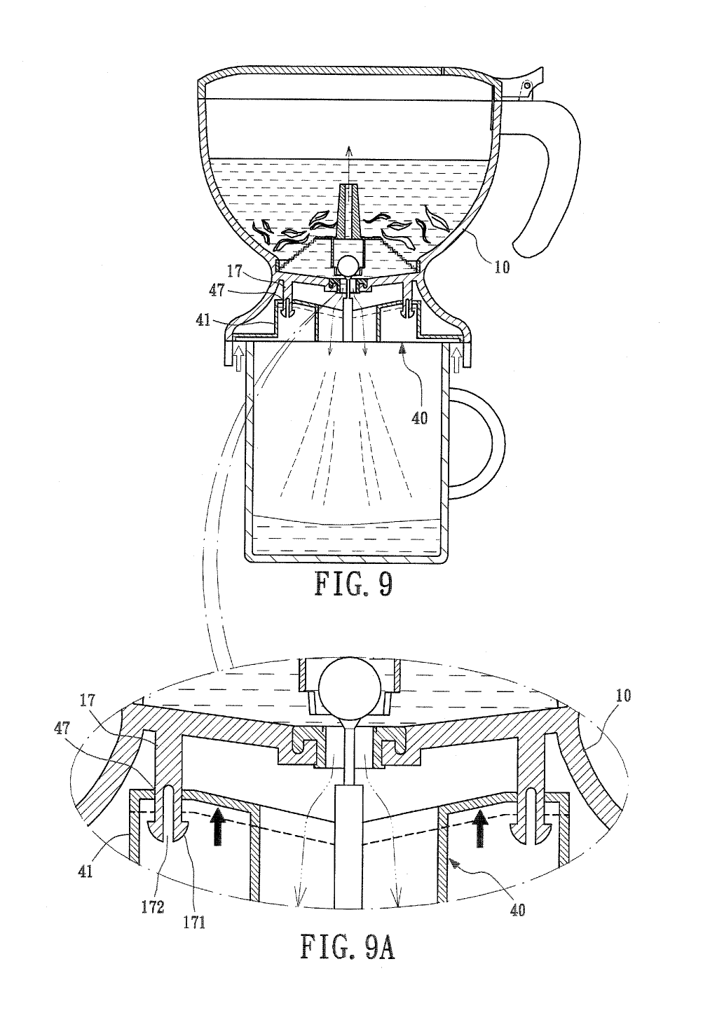

Referring to FIGS. 7, 8, and 9, a different embodiment showing an alternative structure according to the present invention that couples the kettle body 10 and the retention disk 40, wherein the kettle body 10 comprises no ring support and instead, four mounting bars 17 are provided on the bottom of the kettle body 10. The mounting bars 17 have expanded free ends 171 in which a plurality of slits 172 is defined for resilient deformation of the mounting bars 17. The base 41 of the retention disk 40 comprises no pegs and instead, the base 41 forms a plurality of through holes 47 corresponding to the mounting bars 17. The ends 171 are deformable for forcible insertion into the through holes 47, and the ends 171 are then allowed to resiliently resume the original shapes to respectively engage the base 41 for conveniently coupling the retention disk 40 to the bottom of the kettle body 10 without undesired separation. Thus, the retention disk 40 is allowed to stably move upward and downward to ensure smooth discharge of the liquid and prevent undesired leakage.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A brewing kettle, comprising:
a kettle body, which has a bottom forming a through bore, the kettle body being pivotally connected to a cover;
a water stopper, which is movably received in the kettle body;
a screen filter, which is arranged inside and close to the bottom of the kettle body; and
a retention disk, which is mounted under the kettle body through a movable structure and is movable with respect to the kettle body in a vertical direction;
wherein the cover forms a flow guide plate, which guides liquid droplets formed on the cover into the kettle body;
wherein the through bore of the kettle body receives a plug fit therein, the plug forming a through hole having a circumference along which an engagement section is formed for engagement with the water stopper;
wherein the kettle body has a lower circumference from which a projecting wall projects, the projecting wall having a diameter greater than the retention disk and forming a plurality of legs respectively for housing and shielding the retention disk and preventing the kettle body from tipping;
wherein the kettle body forms at least one locking section, which engages an upper side of the screen filter to prevent the screen filter from separation; and
wherein the screen filter forms a grip section that facilitates assembling/disassembling and cleaning, the screen filter forming a positioning section on an underside thereof, whereby the water stopper is received in the positioning section to be maintained on the through bore.

2. The brewing kettle according to claim 1, wherein the cover forms a vent hole.

3. The brewing kettle according to claim 1, wherein the kettle body has an outer surface to which a handle mounted, the handle forming a projection, which is pivotally connected to the cover with a pivot.

4. The brewing kettle according to claim 1, wherein the grip section forms a vent bore.

5. The brewing kettle according to claim 1, wherein the locking section comprises a projecting portion.

6. The brewing kettle according to claim 1, wherein the locking section comprises a circumferential rib.

7. The brewing kettle according to claim 5, wherein the locking section forms an inclined surface.

8. The brewing kettle according to claim 6, wherein the locking section forms an inclined surface.

9. The brewing kettle according to claim 1, wherein the through bore receives a plug that is resilient and forms a through hole, the through hole having an upper circumference along which an engagement section is formed, a groove being formed adjacent to the engagement section to allow for resilient deformability of the engagement section for establishing tight engagement with the water stopper.

10. The brewing kettle according to claim 1, wherein the retention disk forms a raised post for pushing away the water stopper, the raised post forming a recess for holding the water stopper.

11. The brewing kettle according to claim 1, wherein the retention disk has an underside having a central portion forming a conic configuration for guiding liquid flow.
